(19) United States
(12) Patent Application Publication
(10) Pub. No.: US 2011/0113138 A1
(43) Pub. Date: May 12, 2011

(54) SEMANTICALLY ENHANCED SERVICE SWITCHING

(75) Inventors: Olli Tyrkkö, Espoo (FI); Vesa-Veikko Luukkala, Espoo (FI); Antti Lappeteläinen, Espoo (FI)

(73) Assignee: NOKIA CORPORATION, ESPOO (FI)

(21) Appl. No.: 13/000,652

(22) PCT Filed: Jun. 24, 2008
(86) PCT No.: PCT/IB08/01650

§ 371 Date: Dec. 22, 2010

(51) Int. Cl. G06F 15/173

(52) U.S. Cl. 709/224

(57) ABSTRACT

A system for automating service switching in a manner that may be transparent to any actively communicating applications or devices operating in a modular service based system architecture for mobile and embedded devices. An application level entity, such as an application node, may connect to a virtual service, which may be connected to one or more registered services. A switching subsystem may relay communication between the one or more registered services and the application via the virtual service. If a more suitable service becomes available, the switching subsystem may decide to switch from one or more of the registered services to the newly available service via the virtual service.

### BACKGROUND

1. Field of Invention

Various embodiments of the present invention relate to switching, and more specifically, to dynamic service switching between available service entities.

2. Background

In general, software programs may include instruction sets that are executable by a processor, and are further organized to receive input (e.g., data) for use in a calculation or determination resulting in an output. Software technology has evolved to transform these individual instruction sets into program modules that may in turn be integrated together to form the more complex programs. Today's more-sophisticated software programs may receive various forms of input such as raw data, for example as stored in magnetic or optical storage, user input through various known types of user interfaces, measured or monitored information converted to electronic information from electronic and/or electromechanical sensors, etc.

Recently, more flexible modular architectures for sharing information amongst programs are emerging. These programs use modular program units, or “nodes,” that can be revised or replaced without having to interrupt overall device operation.

In general, the availability of various application and service nodes is substantially static in “in-device” architectures. However, in “inter-device” architectures, service nodes can dynamically appear and disappear within the network space. As a result, applications must be constructed to account for problematic situations including, for example, when an in-use service becomes unavailable or disabled. Such failsafe provisions may require the application to expend system resources on continuously polling for new services to appear and switch to the new service if necessary.

No effective solution currently exists for dynamically switching between available service entities so that applications can dynamically switch to a more suitable service without requiring any action from the service requesting applications.

### SUMMARY

Various embodiments of the present invention may include at least a method, apparatus, system and computer program for dynamically switching between service entities in a manner that may be transparent to any actively communicating applications or devices. For example, in modular interconnect-centric service based system architectures (e.g., Network on Terminal Architecture) for mobile and embedded devices application modules may interact interchangeably with various services. An application level entity, such as an application node, may interact with a virtual service, which may be connected to one or more registered services. A switching subsystem may relay communication between the one or more registered services and the application via the virtual service. If a more suitable service becomes available, the switching subsystem may decide to switch from one or more of the registered services to the newly available service via the virtual service.

In at least one exemplary embodiment configured for operation in a Network on Terminal Architecture environment, information provided from application nodes or service level entities may be stored in a semantic information broker (SIB). Any application or service may update, store and query the information stored in the SIB. The switching subsystem may decide to switch service connections based on rules that may operate on the information stored in the SIB.

### DESCRIPTION OF DRAWINGS

The disclosure will be further understood from the following description of various exemplary embodiments, taken in conjunction with appended drawings, in which:

FIG. 1A discloses an exemplary intra-device Network on Terminal Architecture in accordance with at least one exemplary embodiment of the present invention.

FIG. 1B discloses a structural diagram of various exemplary layers of an inter-device Network on Terminal Architecture in accordance with at least one exemplary embodiment of the present invention.

FIG. 2 discloses an exemplary link between two wireless communication devices in accordance with at least one embodiment of the present invention.

FIG. 3A discloses a structural example of communication establishment in accordance with at least one exemplary embodiment of the present invention.

FIG. 3B discloses an example of establishing access to a target service residing in another device in accordance with at least one exemplary embodiment of the present invention.

FIG. 4 discloses an example of various software levels and interfaces through which information may be conveyed in accordance with at least one exemplary embodiment of the present invention.

FIG. 5 discloses an exemplary configuration for the lower level communication structure in accordance with at least one exemplary embodiment of the present invention.

FIG. 6A discloses an example of virtual service registration by the switching subsystem in accordance with at least one exemplary embodiment of the present invention.

FIG. 6B discloses an example of connection establishment between an application node and a virtual service in accordance with at least one embodiment of the present invention.

FIG. 6C discloses an example of a service switching process performed by the switching subsystem in accordance with at least one embodiment of the present invention.

FIG. 7 discloses a flowchart for an exemplary service switching process in accordance with at least one embodiment of the present invention.

### DESCRIPTION OF EXEMPLARY EMBODIMENTS

While the disclosure has been described below in a multitude of exemplary embodiments, various changes can be made therein without departing from the spirit and scope of the invention, as described in the appended claims.

Network on Terminal Architecture (NoTA) is a service based interconnect-centric platform architecture usable in various electronic apparatuses including wired and/or wireless (e.g., mobile) devices. The interconnect-centric approach incorporated in NoTA may allow any physical sub-system to directly communicate with other sub-systems while supporting multiple parallel connections. Direct connections are possible due to simple switches optimized for the underlying physical media. NoTA interconnect architecture and related interfaces may be complexity and performance optimized for service and data communication, and may be designed in such a way that different communication media technologies can be utilized.

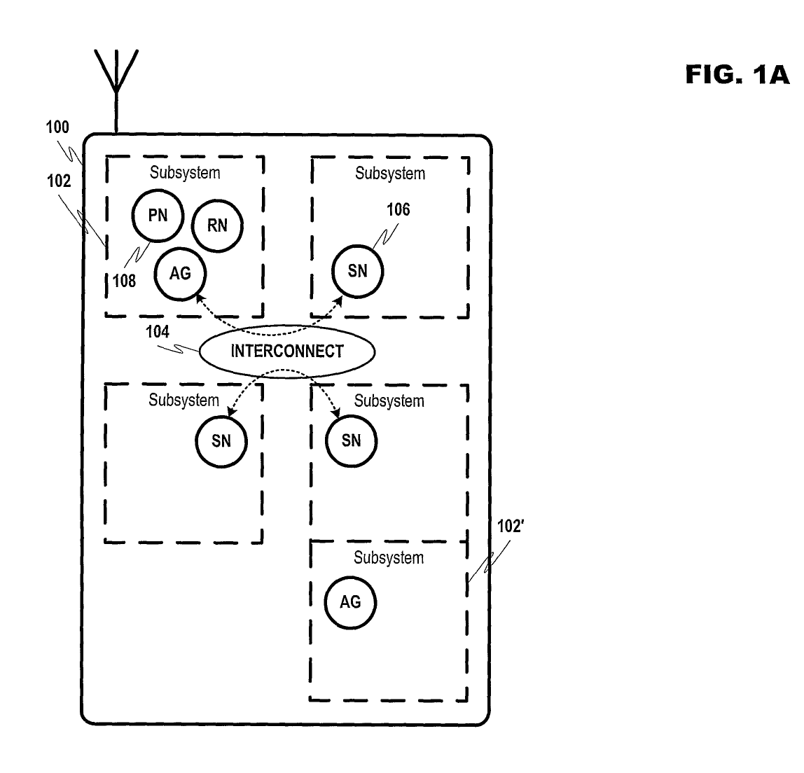

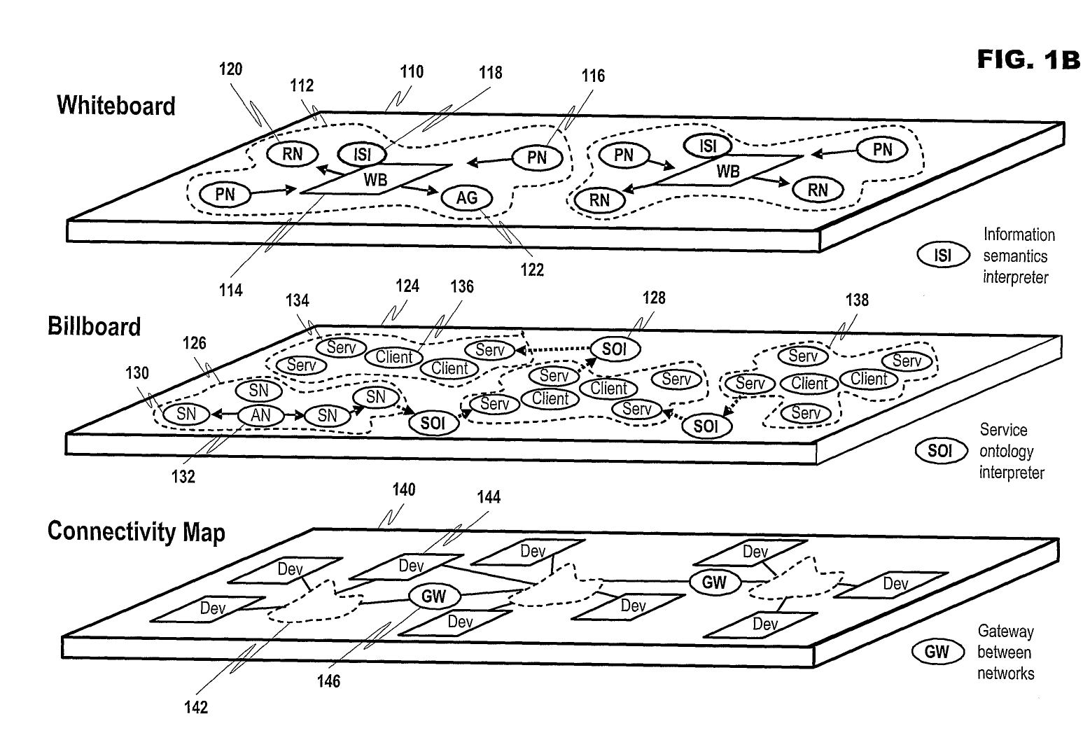

FIG. 1A discloses an example of NoTA implemented in a single device 100. The NoTA platform architecture consists of subsystems 102 connected together via interconnects as shown, for example, at 104. It is also possible for subsystems to be directly coupled to other subsystems as shown at 102′ in FIG. 1A. A coupled configuration may exist in a scenario where subsystems frequently cooperate during operation. FIG. 1A also discloses service nodes (SN) 106 and application nodes (AN) 108 (e.g., proactive nodes (PN), reactive nodes (RN) and agent nodes (AG)) that may be mapped into subsystems 102 and 102′. Subsystems in NoTA context may encompass all of the resources (e.g., computing, software, peripherals, etc.) required to implement the services and/or applications running in the corresponding subsystem.

Now referring to FIG. 1B, a more detailed disclosure of NoTA as it may be applied to a multiple-device system, in accordance with at least one embodiment, is now disclosed. The general architecture may be explained in terms of three exemplary operational levels: whiteboard 110, billboard 122 and connectivity map 140. Whiteboard 110 is an example of an application and service level that may comprise the highest level of operation in this architecture. At this level, operational groups 112 may be formed including whiteboards 114 and various application nodes 108. Application nodes 108 may correspond to applications existing on a plurality of wireless communication devices, and may be utilized to exchange information between these applications, for example, by placing data into, and removing data from, whiteboard 114. For example, the various nodes may consist of proactive nodes 116 that may place information into whiteboard 114, reactive nodes 120 that may take information from whiteboard 114 and agent nodes 122 that may operate either in a PN or RN mode depending on the particular application.

Information semantics interpreter (ISI) 118 may be utilized to link different whiteboards 114 together. Utilizing these constructs, whiteboard 114 may provide a standardized means for application interaction that overcomes many incompatibilities.

Billboard level 124 may facilitate interaction between services available on the one or more devices. Services 134 and clients 136 that may utilize these services may be organized in service domains 126. In at least one scenario, service domains 126 may correspond to a particular protocol, such as Universal Plug n' Play (UPnP), Bluetooth Service Discovery Protocol (BT SDP), Bonjour, etc. In each service domain 126, services 134 may be represented by service nodes (SN) 130, and likewise, application nodes (AN) 132 may be established to correspond to applications. Further, service domains 126 may interact utilizing service ontology interpreters (SOI) 128. SOI 128 may allow service domains 126 to interact with other service domains (e.g., 138), even if service domain 138 resides on another wirelessly-linked device (e.g., to provide access information to service domains 126).

Connectivity map 144 may define connectivity methods/possibilities and topology for different devices participating in sharing resources in order to support a top level, for example whiteboard 110, and also billboard-type services in billboard level 122. In at least one exemplary embodiment of the present invention, devices 144 may be linked in directly connected groups 142. Examples of directly connected groups of devices (Dev) 142 may include devices connected via Bluetooth™ piconet, a WLAN network, a wireless USB link, etc. Each directly connected group of devices 142 may further be linked by gateways (GW) 146.

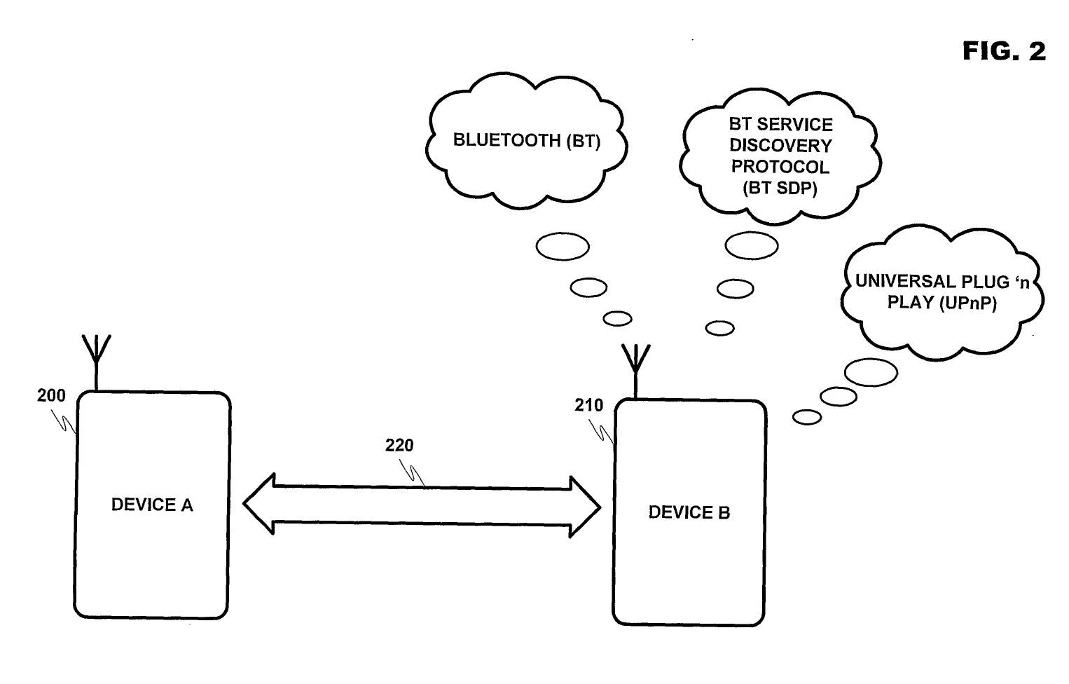

While examples of inter-node interaction involving application and/or service nodes have been described, for the sake of explanation in the present disclosure, a much more rudimentary scenario will be utilized to illustrate service node related functionality. FIG. 2 discloses device A 200 and device B 210. Examples of devices usable in this instance may include various wireless communication devices ranging from very basic wireless devices like wirelessly-enabled sensors or cellular handsets to more complex wirelessly-enabled computing devices like laptop or palmtop computers, wireless communicators, personal digital assistants, or any similar devices with wired connectivity interfaces. The devices disclosed in FIG. 2 may be linked via wireless communication 220 (e.g., WLAN, Bluetooth™, wireless USB, etc.), for example, in order to form an ad-hoc network between the devices. Device B 210 may further include a variety of services and service search mechanism such as Bluetooth™ related BT SDP and UPnP. Under existing architecture schemes, device A 200 would not be aware of these services over wireless link 220, and further, even if device A 200 was aware, most or all of these services would probably be inaccessible due to various incompatibility issues existing between services. As a result, wireless coupling 220 between Device A 200 and Device B 210 may only be beneficial for conveying information, since no access to remote services is available.

A service may be defined as the functionality offered or derived from a particular software program, or from dedicated hardware which may require some software for operation. Services may pertain to all aspects of device functionality. Services may be provided, for example, by an operating system loaded on a wireless communication device, or may be added to the device by accessory applications related to communication, security, productivity, device resource management, entertainment, etc. In accordance with at least one embodiment of the present invention, one or more service nodes may be established to correspond to services available on the one or more devices.

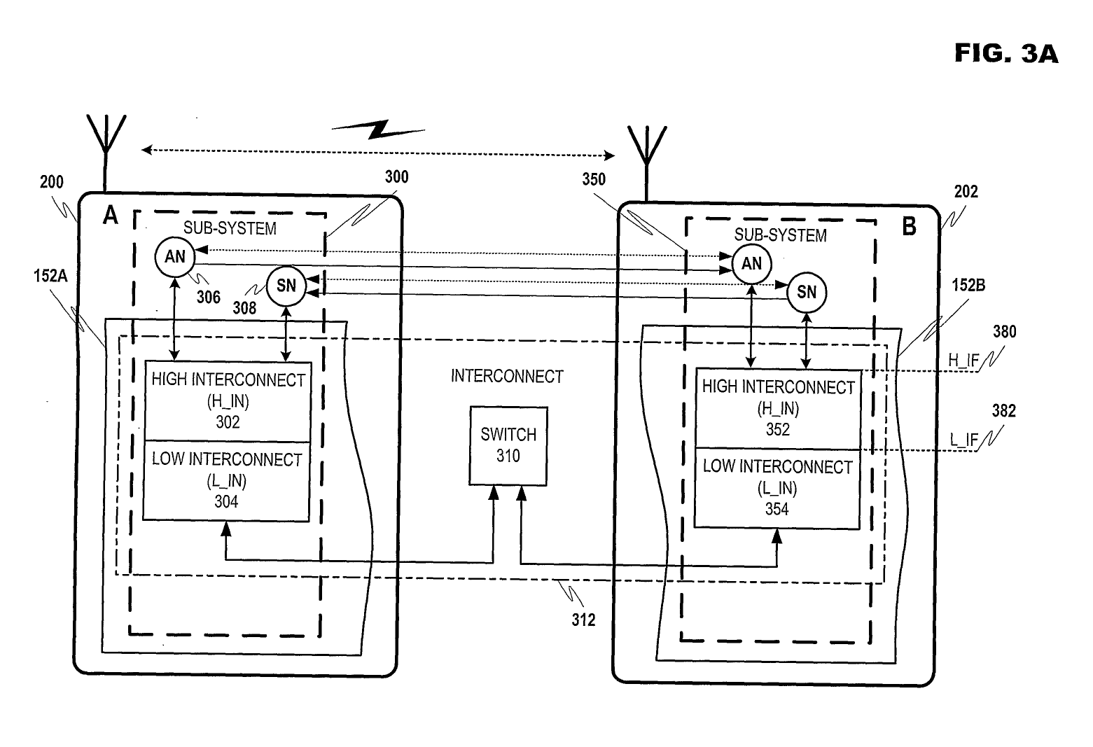

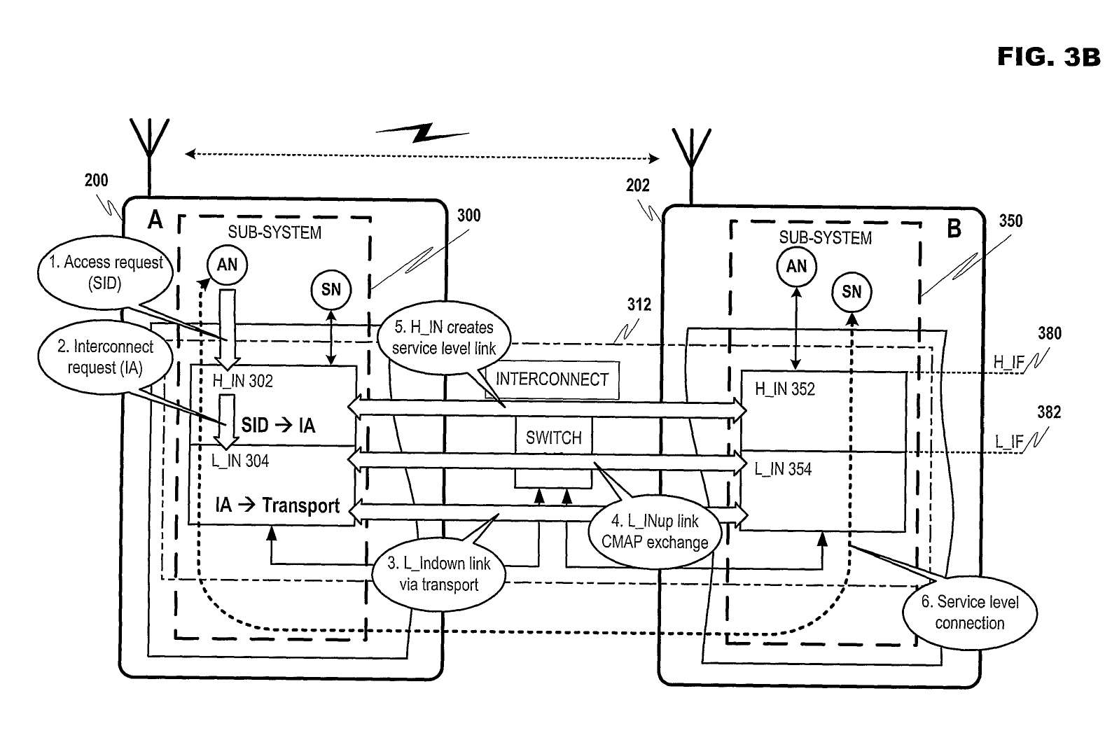

FIG. 3A discloses an example of an underlying logical architecture that may be utilized in implementing NoTA in accordance with at least one exemplary embodiment of the present invention. NoTA may be configured as multiple subsystems (e.g., 300 and 350) coupled by interconnect 312. As previously set forth, a communication link between devices that may be both established and managed by a lower operational level may facilitate the routing of messages for higher level subsystems, such as sections (152A and 152B) of the same shared memory space (whiteboard) 152, without the actual involvement of the higher levels in any communication configuration. NoTA interconnect 312 may comprise two layers: High Interconnect (H_IN) layer 302 and Low Interconnect (L_IN) layer 304 coupled to corresponding H_IN 352 and L_IN 354 by switch 310. The various communication layers may further interact over interfaces (abbreviated “IF” in FIG. 3). For example, H_IF 380 may serve as the interface between the application level and H_IN 302/352, while L_IF 382 may serve as the interface between H_IN 302/352 and L_IN 304/354. Low interconnect layer 304 may include ISO/OSI layers L1-L4 and may provide transport socket type interface upwards. High Interconnect layer 302 may act as the middleware between L_IN 304 and the higher level application nodes 306 (AN) and service nodes (SN) 308 residing in subsystems like 300 and 350. Key H_IN 302 functionality may include providing client nodes (AN 306 or SN 308) a direct access to services without having to disclose the location of the latter (e.g., transparent at the top level). All communication establishment may be connection-oriented, meaning that before any service or data communication may take place, connection setup procedures must first be carried out. Security features have been added to countermeasure identified threats. NoTA is an architecture that may be used to provide inter-device service access, making it possible to build independent subsystems providing both services and applications. In an exemplary implementation there may be several individual NoTA devices involved in direct inter sub-system communication.

Utilizing the previously described architecture, an example of establishing access to a service on another device via a wireless link, in accordance with at least one exemplary embodiment of the present invention, is disclosed in FIG. 3B. A node in the application/service level of subsystem 300 in device 200 desires to access a service. The service may be identified, for example, by a service identification (SID). The SID may be used to locate and establish access to the desired service. In the H_IN level, the SID may be mapped to an interconnect address (IA) that may further identify the subsystem in which the service resides. In this example, the desired service resides in subsystem 350 in target device 202. In order to make an H_IN level connection with the subsystem offering this service, a transport must be selected that is suitable for making a connection between the devices. The IA may then be mapped to the selected transport in L_IN 304. In the example of FIG. 3B, a wireless link must be established because the devices are not coupled by a wired connection. This wireless link is established over interconnect 312 via the wireless transport. Once devices 200 and 202 are wirelessly coupled, H_IN level connection between subsystem 300 and 350 may be possible. In H_IN level 352 a corresponding H_IN protocol is usable to negotiate service usage. The mapping of SID to IA and IA to transport is used only in subsystem 300 in order to build a connection with a proper subsystem offering the needed service (e.g., subsystem 350). As a result, upper level (e.g., application/service level) access may be established from a requesting node in device 200 to a service that is able to fulfill the request, even though the service resides in device 202. This access may be facilitated by lower level link establishment via one or more transports.

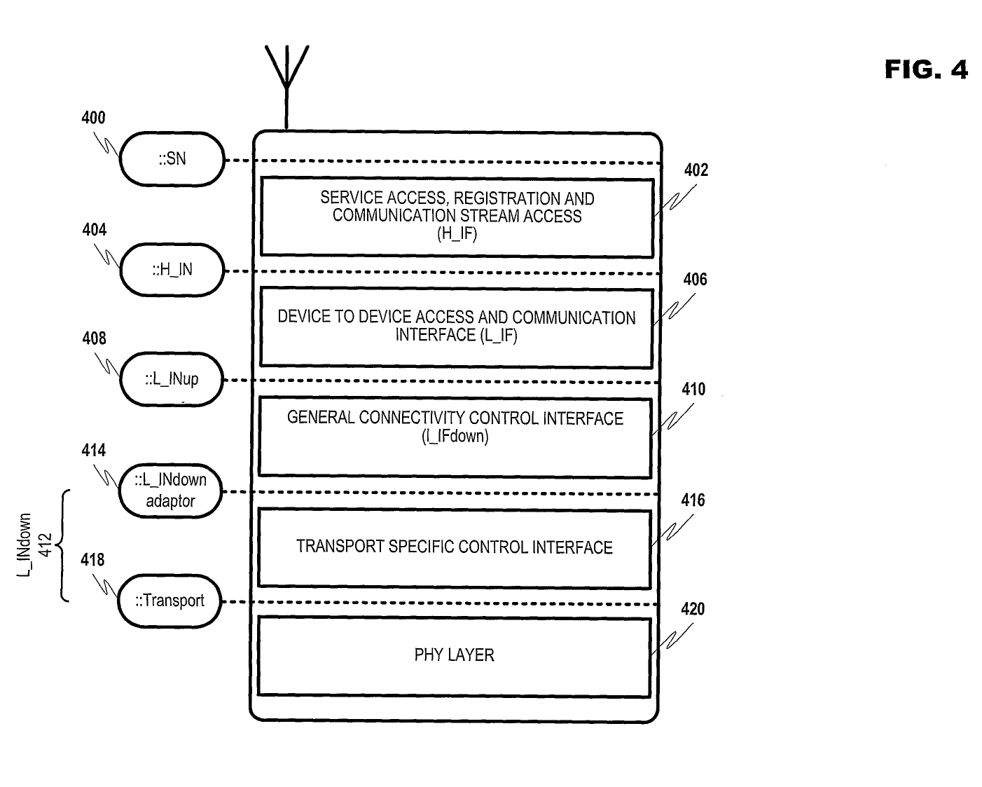

The present invention, in accordance with at least one embodiment, may be described in terms of the functionality of various architecture components and component relations. FIG. 4 describes the interaction of the various communication levels and examples of functions that may be performed by each level and its corresponding interface in accordance with at least one exemplary embodiment of the present invention. For example, 400 discloses an exemplary service node (SN) that may facilitate the set-up and establishment of connections supporting various application nodes (AN) such as 108 shown in FIG. 1A. The interface between the top application level and the H_IN level 404 may provide service access, registration and communication stream access via H_IF interface level 402. In accordance with at least one exemplary embodiment of the present invention, services may be identified by a service identification (SID). H_IN level 404 may then obtain device-to-device access and communication interface access to L_INup level 408 via L_IF interface level 406. The H_IN level access may be identified by an interconnect address (IA) which separates different devices/subsystems in high level middleware layer. A general connectivity control interface L_IFdown level 410 may then provide access from transport-independent L_INup level 408 to L_IN down 412 including transport-specific L_IN adaptors as disclosed at 414. In various embodiments of the present invention, there may be a specific L_IN adaptor 414 for each communication medium (e.g., transport 418), each being linked by transport-specific control interfaces 416. Wired and/or wireless transports 418 supported, for example in a mobile device, may then utilize the physical hardware and/or corresponding software in device physical (PHY) layer 420 to communicate. Overall, the service level may utilize an SID to identify different services, H_IN level middleware layer may then map this SID into a certain IA, which corresponds to an address of a device/subsystem where the respective service may be accessed in the high level middleware layer. L_INup level 408 may then map this IA to one or more physical connections (e.g., transports) that may offer connectivity to the device/subsystem that corresponds to the IA. L_INdown level 410 may then establish physical connections with the specific transport.

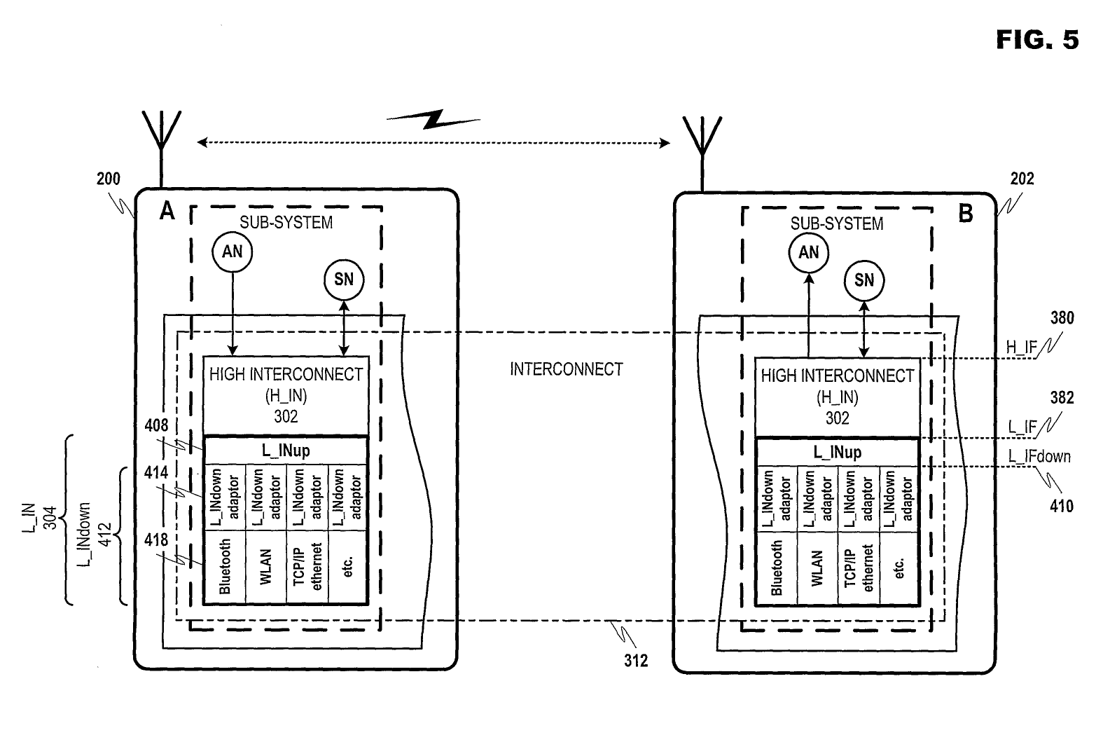

FIG. 5 depicts an exemplary low interconnect architecture (L_IN) 304, in accordance with at least one exemplary embodiment of the present invention. L_IN 304 may provide service upwards to H_IN 302 via L_IF interface 382, and may comprise a unified L_INup communication structure 408 and one or more L_INdown communication structures 412. L_INdown 412 may further include at least one L_INdown adaptor 414 corresponding to each transport 418 that may be utilized in a device. As a result, L_INup 408 may be transport-independent (e.g., L_INup operation does not change in dependence upon the transport in use), while L_INdown adaptors 414 in L_INdown 412 may be specifically configured for use with each transport 418. Each L_INdown adaptor 414 may provide service to L_INup 408 through one or more L_IFdown interface 410. L_IFdown interfaces 410 may be configured similarly for each transport 418 except in the addressing and access mechanism.

L_INup 408 may perform multiple functions in embodiments of the present invention. For example, activation and deactivation may be controlled in this layer of the communication structure. The L_IN activation process is controlled over the L_IF 382. During the activation process, the L_IN 304 may be configured to be able to use wireless and/or wired transports as L_IN transports. As a result of successful activation, L_IN 304 may then be able to resolve an interconnect address (IA). L_INup 408 may use the query services provided to L_INdown 412 during this activation.

When active, L_IN 304 may be able to detect loss of a L_IN network connection. As a result, any earlier allocated IA may be released in order to, for example, automatically reconnect the network connection using the same or a different transport. The deactivation process is also controlled over L_IF 382. In the deactivation process, L_IN 304 is deactivated in respect of all available transports. During this process, the interconnect address is released.

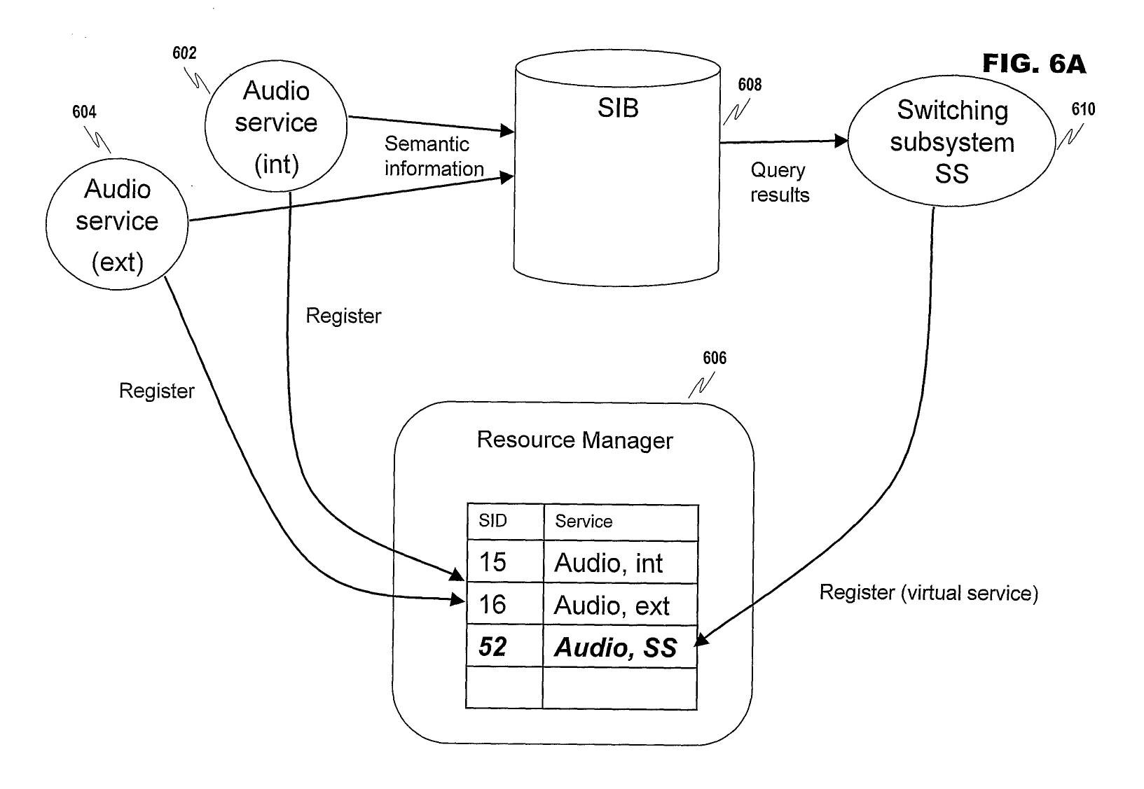

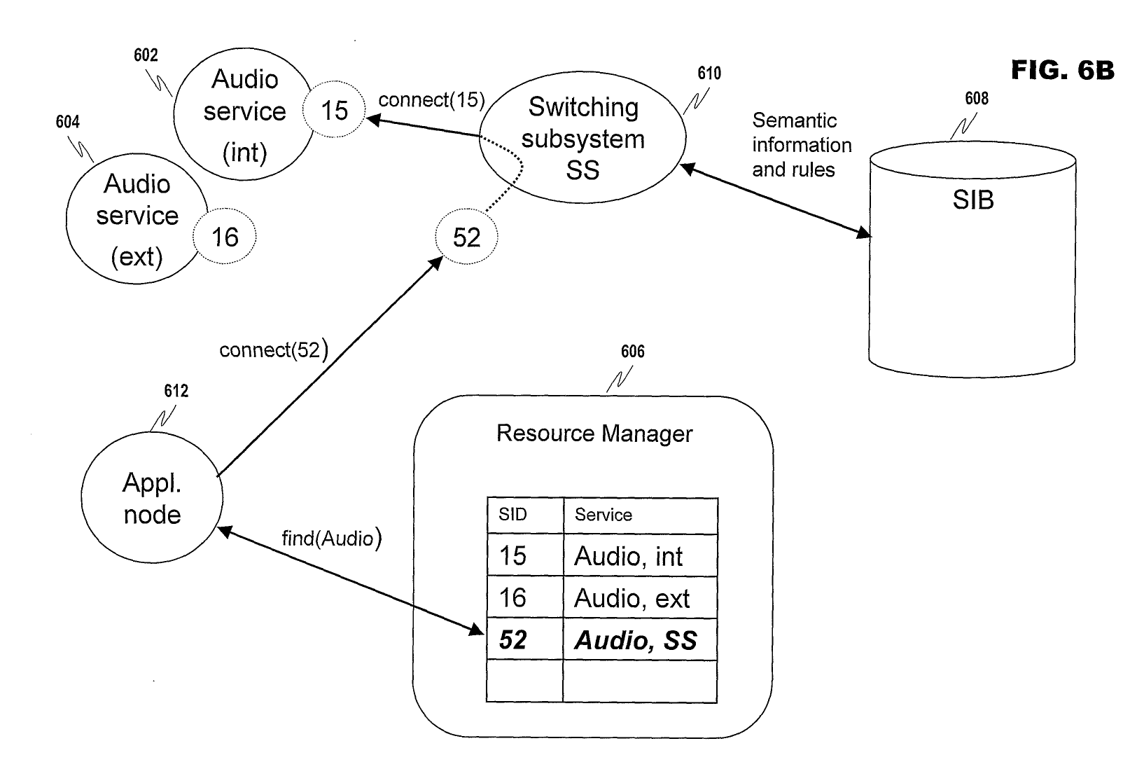

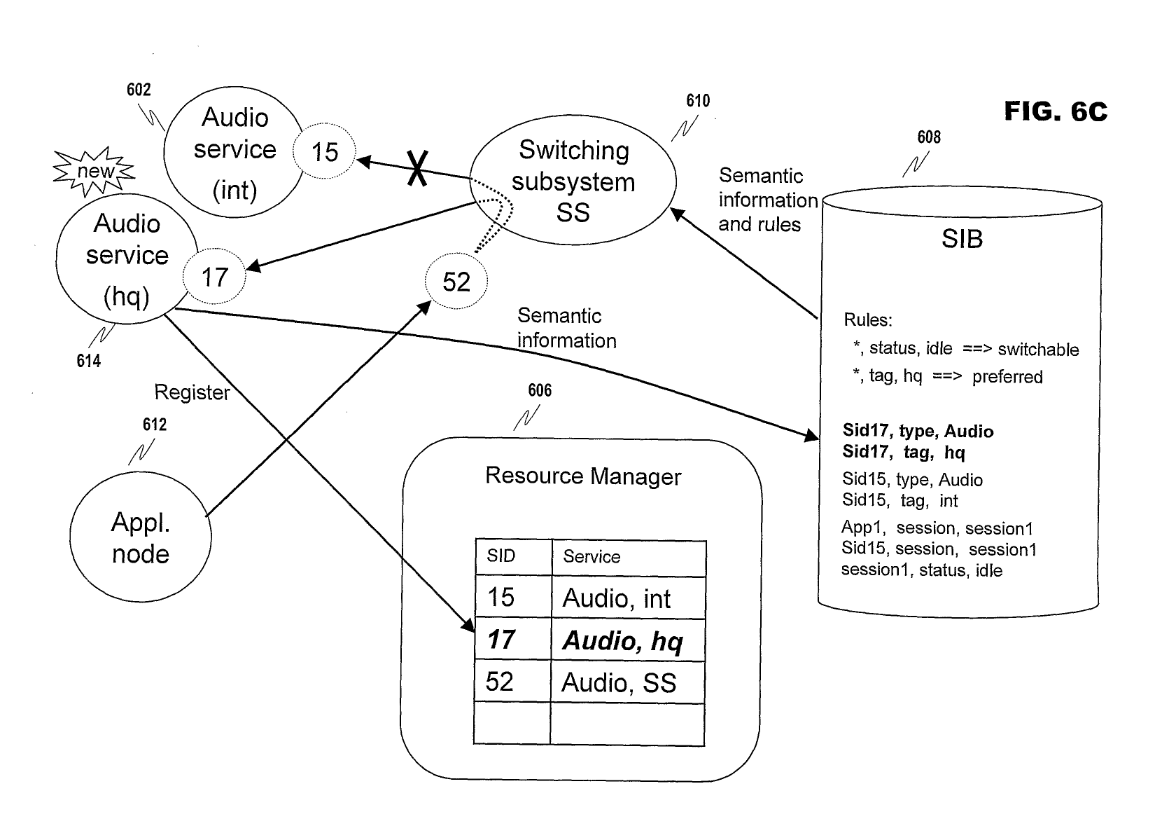

FIG. 6A discloses an exemplary implementation of the present invention, in accordance with at least one embodiment, wherein services may be registered in a resource manager 606. In the exemplary embodiment shown in FIG. 6A, there are two audio service implementations (602 and 604) which may be registered in resource manager 606. Services 602 and 604 may register themselves in the resource manager 606 with their SID's. Each service may have its own SID in the resource manager 606. If for instance, several services exist for the same service type, such as audio services 602 and 604, each service may get its own entry, with its own SID in the resource manager 606 as shown in FIG. 6A. Resource manager 606 may also store additional information related to the services. For example, audio service 602 may include a tag, such as “int” which may indicate the presence of additional metadata that the service may provide. In this example, “int” may indicate that service 602 is an internal service. Similarly, audio service 604 may include a tag such as “ext” indicating that it is an external service. Additionally, audio services 602 and 604 may provide information such as the provider of the service, version number, information regarding the service quality, etc.

Application nodes wishing to connect to a service may consult resource manager 606 to find a particular service. If as shown in FIG. 6A, the resource manager 606 includes several services of the same service type as sought by the application node, for instance audio services 602 and 604, the application node may select from the available services. In accordance with an exemplary embodiment, the resource manager may be a dedicated NoTA resource manager.

The exemplary implementation shown in FIG. 6A also includes a subsystem providing semantic information broker (SIB) service. The SIB 608 may also be implemented as a NoTA service and may store information in the form of triples (e.g., subject, predicate, object). SIB 608 may store semantic information of the services 602 and 604 and may also store information relating to their connection status. In this example, SIB 608 may also store information such as, for example, names of producers of songs, names of manufacturers, resolution of a video, battery cost of using the service, etc. It should be noted that the information stored in the SIB 608 may be provided by the services directly or alternatively may be provided by other sources such as application nodes or devices. SIB 608 may allow service or application nodes to add to, query or update the information stored in SIB 608. Additionally, SIB 608 may also store rules which operate on the information stored in SIB 608. The rules may be utilized by switching subsystem 608 to make various decisions as described in further detail in the description of FIGS. 6B and 6C.

Furthermore, if a new entity (e.g., service, application node, device, etc.) containing its own SIB including semantic information relating to that entity, joins the NoTA network shown in FIG. 6A, SIB 608 may copy the contents of the new SIB. Alternatively, both SIBs may be virtually merged such that the combined information from both SIBs may be used to evaluate any queries.

As shown in the exemplary implementation shown in FIG. 6A, switching subsystem 610, may monitor the registered services in the resource manager 606 and for each switchable service type, may register a virtual service of that type. For example, FIG. 6A discloses two audio services 602 and 604 that provide the same service type (e.g., audio). Thus, switching subsystem 610 may register an audio virtual service. The virtual service may receive its own SID in the resource manager 606 and may additionally be tagged as a virtual or switching service so that it may be distinguished from an actual service node by an application node or device.

In accordance with the exemplary embodiment shown in FIG. 6B, an application node 612 in search of an audio service, may consult the resource manager 606 for the appropriate service. The application node 612 may request to connect to virtual service 52. However, because service 52 is a virtual service, application node 612 may actually be connected to switching subsystem 610. Switching subsystem 610 may in turn select a target service corresponding to virtual service 52 based on the semantic information and rules stored in SIB 608. For example, rules may state that audio services of one manufacturer are preferred over audio services from other manufacturers, that internal audio services are preferred over external audio services, etc. In the exemplary embodiment of FIG. 6B, switching subsystem 610 may select, based on the rules stored in SIB 608, and establish a connection with audio service 602. Additionally, switching subsystem 610 may also determine the configuration of the connection based on the rules and/or information stored in SIB 608.

Switching subsystem 610 may act as a relay point for connections to target services such that it may relay communication between the application node and the target service via the virtual service. In the exemplary embodiment of FIG. 6B, switching subsystem 610 relays communication between application node 612 and target audio service 602 via the virtual service 52.

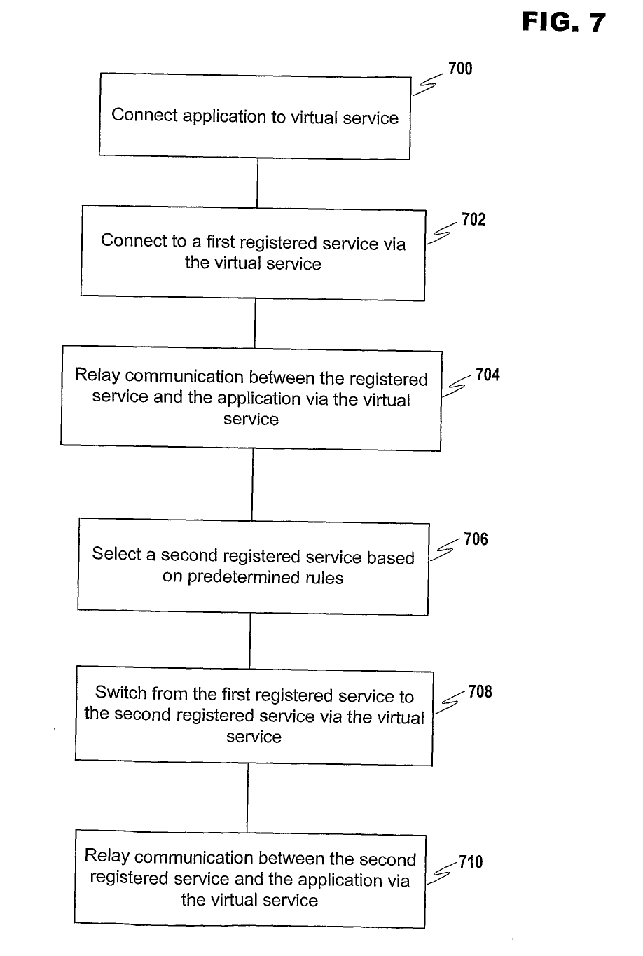

A flowchart describing a process flow in accordance with at least one exemplary embodiment of the present invention is now disclosed with respect to FIG. 7. In step 700, a switching subsystem may connect an application node to a virtual service which may be registered in a resource manager. The virtual service may be connected to one or more registered services. Switching subsystem may then connect to a registered service corresponding to the virtual service via the virtual service in step 702. The switching subsystem may act as a relay point and relay communication between the registered service and the application node via the virtual service as shown in step 704. If a new registered service (second registered service in FIG. 7) becomes available and satisfies rules stored in a SIB, the switching subsystem may select the new service (second registered service in FIG. 7) as shown in step 706. In step 708, the switching subsystem may switch its connection from the first registered service to the new service (second registered service in FIG. 7) via the virtual service. Selecting a second registered service and deciding to switch from the first registered service o the second registered service may be based on predetermined rules which may be stored in a SIB or in local storage in the switching subsystem. Switching subsystem may disconnect from the first registered service and connect to the new service(second registered service in FIG. 7).

In accordance with an exemplary embodiment, the switching subsystem may disconnect from the first registered service based on the state of the first registered service. Switching subsystem may monitor the state of the first registered service, and based on predetermined rules relating to the state of the first registered service, determine a suitable time to disconnect from the first registered service. The predetermined rules may be retrieved from an SIB by searching or querying the SIB or may be retrieved from local storage in the switching subsystem. In step 710, the switching subsystem may relay communication between the new service (second registered service in FIG. 7) and the application node via the virtual service. In addition, upon connecting to the second registered service, the switching subsystem may control the state of the second registered service to be the same as the state of the first registered service at the time of disconnection from the first registered service. The state of the second registered service may be controlled based on predetermined rules which may be stored in a SIB or in the switching subsystem.

The exemplary embodiment shown in FIG. 6C, discloses how switching subsystem 610 may dynamically change the relaying setup in accordance with the rules stored in SIB 608. In the example shown in FIG. 6C, application node 612 is connected to virtual service 52, and switching subsystem 610 is relaying communication between application node 612 and audio service 602 via virtual service 52. The status of this connection and information pertaining to the services may be stored in SIB 608 as previously described and as shown in FIG. 6C. When a new service such as audio service 614 becomes available, it may register itself in resource manager 606 and update or add its semantic information in SIB 608. Switching subsystem 610 may then process the information and rules stored in SIB 608. In the example of FIG. 6C, the rules indicate that a service is switchable when its status is idle and that a service with tag “hq” is preferred. A decision to perform the switch may be implemented based on many factors. For example, services that provide better quality audio may be preferred or services which have a low battery consumption may be preferred. Based on the rules, switching subsystem 610 may determine whether to switch services, what service to switch to, a suitable time to switch, etc. In this example, switching subsystem 610 decides to switch to audio service 614. Switching subsystem 610 may establish a new connection to audio service 614 and may relay communication between application node 612 and audio service 614 via virtual service 52. In addition, switching subsystem 610 may disconnect from audio service 602 such that no data is lost and that pending transactions are properly resolved. The switching subsystem 610 may then update SIB 608 to reflect the new configuration (not shown). In accordance with an exemplary embodiment, the switching process performed by switching subsystem 610 may be transparent to application node 612. In other words, application node 612 may remain connected to virtual service 52 during the switching process. Additionally, application node 612 may not have to make any decisions regarding which service to select, but may instead rely on the decisions made by the switching subsystem 610.

In accordance with an exemplary embodiment, the present invention is not limited to a NoTA environment, and may be implemented in, for example, a Bluetooth™ (BT) environment. In such an exemplary embodiment, services available through a Bluetooth link may make their service descriptions available through a BT Service Discovery Protocol (SDP). Available services may add or update their semantic information to the SIB, which may also be implemented as a BT service and be visible through the BT SDP. The semantic information may be associated with entries in the SDP and with BT MAC addresses.

In accordance with an exemplary embodiment, when a Bluetooth device may discover services in another Bluetooth device, it may also discover the SIB service of the discovered device. The discovering device may then copy the contents of the discovered SIB to its local SIB or alternatively, may virtually merge the SIBs as previously described. The discovering device may then decide which of the available services to use or determine which service to switch to based on the information and rules in the SIB.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

1. A method, comprising:
connecting an application to a virtual service, the virtual service being further connected to one or more registered services;
connecting to a first registered service via the virtual service;
relaying communication between the first registered service and the application via the virtual service;
selecting a second registered service;
switching from the first registered service to the second registered service via the virtual service; and
relaying communication between the second registered service and the application via the virtual service.

2. The method according to claim 1, further comprising:
registering the virtual service in a resource manager.

3. The method according to claim 1, wherein switching from the first registered service to the second registered service includes disconnecting from the first registered service and connecting to the second registered service.

4. The method according to claim 1, further comprising:
registering the virtual service in a service discovery protocol.

5. The method according to claim 1, wherein the second registered service is selected based on predetermined rules.

6. The method according to claim 1, wherein a decision to switch from the first registered service to the second registered service is based on predetermined rules.

7-8. (canceled)

9. The method according to claim 1, wherein switching from the first registered service to the second registered service includes monitoring a state of the first registered service and disconnecting from the first registered service based on the state and predetermined rules.

10. The method according to claim 1, wherein switching from the first registered service to the second registered service includes controlling a state of the second registered service to be substantially same as a state of the first registered service at a time of disconnection from the first registered service.

11. An apparatus, comprising:
at least one communication module configured to support one or more wired or wireless transports; and
a processor coupled to the at least one communication module, the processor being configured to:
connect an application to a virtual service, the virtual service being further connected to one or more registered services;
connect to a first registered service via the virtual service;
relay communication between the first registered service and the application via the virtual service;
select a second registered service;
switch from the first registered service to the second registered service via the virtual service; and
relay communication between the second registered service and the application via the virtual service.

12. The apparatus according to claim 11, wherein the processor is further configured to register the virtual service in a resource manager.

13. The apparatus according to claim 11, wherein switching from the first registered service to the second registered service includes disconnecting from the first registered service and connecting to the second registered service.

14. The apparatus according to claim 11, wherein the processor is further configured to register the virtual service in a service discovery protocol.

15. The apparatus according to claim 11, wherein the processor is further configured to select the second registered service based on predetermined rules.

16. The apparatus according to claim 11, wherein the processor is further configured to switch from the first registered service to the second registered service based on predetermined rules.

17. The apparatus according to claim 15, wherein the predetermined rules are retrieved from an information storage apparatus.

18. The apparatus according to claim 16, wherein the predetermined rules are retrieved from an information storage apparatus.

19. The apparatus according to claim 11, wherein the processor is further configured to monitor a state of the first registered service and disconnect from the first registered service based on the state and predetermined rules.

20. The apparatus according to claim 11, wherein the processor is further configured to control a state of the second registered service to be substantially same as a state of the first registered service at a time of disconnection from the first registered service.

21. A system, comprising:
a communication device; and
a switching apparatus, the switching apparatus configured to:
connect the communication device to a virtual service, the virtual service being further connected to one or more registered services;
connect to a first registered service via the virtual service;
relay communication between the first registered service and the communication device via the virtual service;
select a second registered service;
switch from the first registered service to the second registered service via the virtual service; and
relay communication between the second registered service and the communication device via the virtual service.

22. The system according to claim 21, wherein the switching apparatus is further configured to register the virtual service in a resource manager.

23-25. (canceled)
